(19) United States
(12) Patent Application Publication
(10) Pub. No.: US 2010/0066528 A1
(43) Pub. Date: Mar. 18, 2010

(54) AUTOMATIC FLASHING BRAKE LIGHTS AND ASSOCIATED METHOD

(76) Inventor: PETER P. KIM, Fountain Valley, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 12/561,256

(22) Filed: Sep. 16, 2009

Related U.S. Application Data
(60) Provisional application No. 61/192,216, filed on Sep. 16, 2008.

(51) Int. Cl. B60Q 1/44

(52) U.S. Cl. 340/479

(57) ABSTRACT

An automatic vehicle brake light flashing system for identifying an extremity of a vehicle braking force includes a plurality of brake lights connected to a G-force meter. A power supply source transmits a brake power signal to the G-force meter only when the brake switch is activated during vehicle braking procedures. The G-force meter determines a G-force value inside the vehicle only upon receiving the brake power signal. A processor generates and transmits corresponding brake light signals to the brake lights so that the brake lights are caused to flash at different frequencies upon automatically receiving the corresponding brake light signals. Such frequencies may include: fast flashing brake lights for hand force braking/sudden stopping; moderately slow flashing brake light for medium force braking; regular solid brake light for light braking; and contestant emergency warning flashing lights for front and rear end collisions.

### CROSS REFERENCE TO RELATED APPLICATIONS

This application claims the benefit of U.S. Provisional Application No. 61/192,216, filed Sep. 16, 2008, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a brake light system for vehicles and, more particularly, to a flashing brake light system that utilizes a G-force meter unit, central processor unit, fast rate flasher, slow rate flasher, no signal detection unit, several relay systems, and communication links for flashing vehicle brake lights in alternate patterns.

2. Prior Art

The National Highway Traffic Safety Administration (NHTSA) reported that rear-impact collisions result in more injuries and property damage than any other type of automobile accident. Over 2.5 million rear-impact collisions occurred in 1999, causing 2,149 deaths. The NHTSA stated in 2001 that an extra second of warning time could prevent 90% of all rear-impact collisions; averting 2.25 million rear-end crashes a year. Center High Mounted Stop Lights (Third Brake Light) have displayed long-term effectiveness in reducing rear impact crashes by 4.3 percent in passenger cars and lightweight trucks. Even a 4 percent reduction in rear-end collisions may represent some 25,000 injuries prevented each year. Statistics show that just adding Center High Mounted Stop Lights (Third Brake Light: since 1986) prevent 92,000 to 137,000 police-reported crashes, 58,000 to 70,000 nonfatal injuries, and $655 million in property damage a year. Adding more visible brake lights can do such a great job preventing rear impact crashes.

Rear-impact collisions account for more than 20% of all motor vehicle crashes. In 1993, for example, it is estimated that there were more than 1.5 million rear-impact crashes, and over 600,000 injured occupants. Michael Flannagan, a research professor at the University of Michigan's Transportation Research Institute stated that there are a finite amount of signals drivers can be expected to respond to, but any modification that can add even a fraction of a second to a driver's reaction time and potentially reduce the 40,000 fatalities on U.S. roads from automobile accidents each year, which cost the economy some $230 billion a year, or about $820 per person according to the NHTSA, is important.

In European testing, Mercedes found that drivers reacting to flashing brake lights hit the brake in 0.4 seconds, slightly faster that the 0.6 seconds it took them to react to a regular brake light. People's reaction time is quicker with flashing brake lights than without. The studies found that at a speed of 50 mph the increased reaction time reduces the stopping distance by approximately 14.5 feet and at 65 mph by around 20 feet. What this means is that a brake system equipped with better visibility and quicker recognition can do great work towards the prevention of a collision accident.

Although conventional brake lights show the lead vehicle to be braking, they give no further indication about the brake force and the resulting deceleration. Presently, the vehicle rear brake lights stay on continuously when activated. Oftentimes, this is not noticeable to the trailing driver for a number of reasons, which may include boredom, tiredness, distraction, inexperience, age, medicinal effects, etc. The situation may be further compounded when the leading car lights are on, whether it is day or night. The blending of brake lights and other lights at nighttime can become difficult to differentiate. This problem is further intensified under adverse weather conditions (rain, fog, etc). Accordingly, there is a need to provide a system that provides automatic flashing brake lights to overcome the above-noted shortcomings.

### BRIEF SUMMARY OF THE INVENTION

In view of the foregoing background, it is therefore an object of the present invention to provide an automatic vehicle brake light flashing system for identifying an extremity of a vehicle braking force. These and other objects, features, and advantages of the invention are provided by the automatic vehicle brake light flashing system including a plurality of brake lights adapted to be connected to an existing vehicle, a power supply source, a G-force meter, and a brake switch communicatively coupled to the G-force meter and the power supply source respectively.

Notably, such a power supply source transmits a brake power signal to the G-force meter only when the brake switch is activated during vehicle braking procedures. In this manner, the G-force meter determines a G-force value inside the vehicle only upon receiving the brake power signal.

A processor may be communicatively coupled to the G-force meter and may be responsive to the G-force value such that the processor generates and transmits corresponding brake light signals to selected ones of the brake lights. In this manner, the brake lights are caused to flash at different frequencies upon receiving the corresponding brake light signals.

In one embodiment, the present invention may further include a plurality of flasher devices for altering the different frequencies, as well as a plurality of communication links communicatively coupled to the flasher devices and the brake lights respectively.

In one embodiment, the flasher devices my include a fast flasher device communicatively coupled to the processor and thereby receiving a high one of the G-force values via a first one of the communication links. In addition, a slow flasher device may be communicatively coupled to the processor and thereby receives a medium one of the G-force values via a second one of the communication links.

In one embodiment, a no signal detection unit may be communicatively coupled to the processor as well as the fast and slow flasher units respectively via a third one of the communication links. In this manner, a weak one of the G-force values may be communicated to the no signal detection unit via the third communication link.

In one embodiment, a plurality of relay switches may be communicatively coupled to the G-force meter, wherein an extremely high positive G-force value and an extremely high negative G-force value is transmitted to an emergency one of the brake lights via the slower flasher device and the relay switches respectively. In this manner, the no signal detection unit will trigger to receive the brake power signal via a first one of the relay switches during system failure such that the first and second relay switches receive the brake light signals and thereafter relay the brake light signals to left and right ones of the brake lights as well as a third one of the brake lights respectively.

The present invention further includes a method of utilizing an automatic vehicle brake light flashing system for identifying an extremity of a vehicle braking force. Such a method preferably includes the chronological steps of: providing and connecting a plurality of brake lights to an existing vehicle; providing a power supply source; providing a G-force meter; providing communicatively coupling a brake switch to the G-force meter and the power supply source respectively.

Such a method may further include the chronological steps of: the power supply source transmitting a brake power signal to the G-force meter only when the brake switch is activated during vehicle braking procedures; the G-force meter determining a G-force value inside the vehicle only upon receiving the brake power signal; providing and communicatively coupling a processor to the G-force meter and being responsive to the G-force value; the processor generating and transmitting corresponding brake light signals to selected ones of the brake lights; and upon receiving the corresponding brake light signals, the brake lights to flash at different frequencies.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a schematic block diagram view showing the interrelationship between the major electronic components of the present invention, in accordance with one embodiment of the present invention—Type I (Automatic Flashing Light Full version); and

FIG. 2 is a schematic block diagram view showing the interrelationship between the major electronic components of the present invention, in accordance with one embodiment of the present invention—Type II (Automatic Flashing Brake Light Simpler Version);

FIG. 3 is an exemplary illustration of a gravity-actuated G-force meter that displays the numerical values sued by the present invention; and

FIG. 4 is a portable housing that contains the processor, G-force meter, flasher devices, relay switches, and no signal detection unit.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes or proportions shown in the figures.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

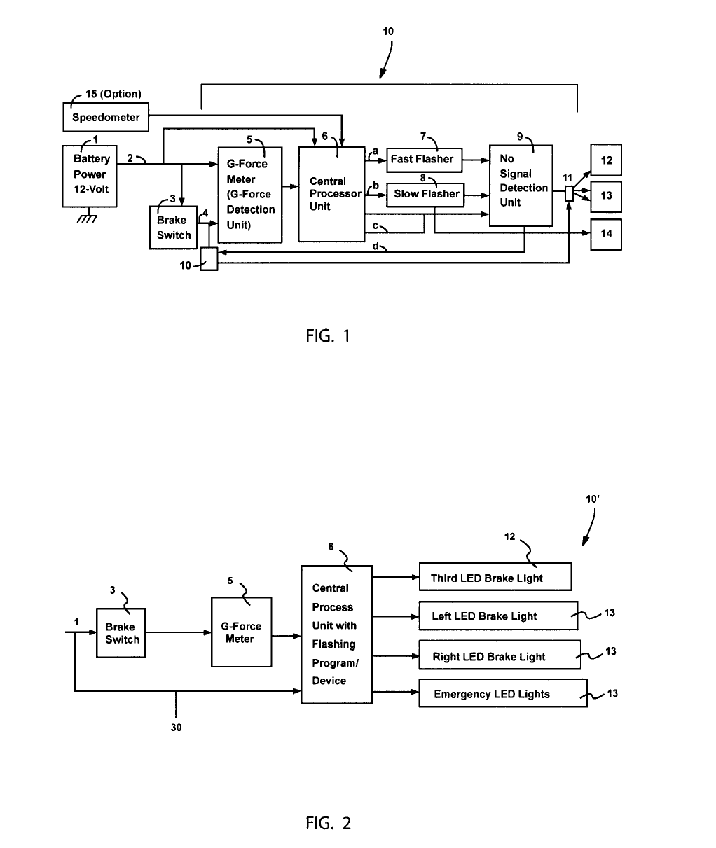

The device of this invention is referred to generally in FIGS. 1-4 by the reference numeral 10 and is intended to provide an automatic flashing brake light system (AFBL). It should be understood that the AFBL 10 may be used to flash many different types of vehicle brake lights. The automatic vehicle brake light flashing system 10 preferably includes a plurality of brake lights 12-14 adapted to be connected to an existing vehicle, a power supply source 1, a G-force meter 5, and a brake switch 3 communicatively coupled to the G-force meter 5 and the power supply source 1, respectively.

Notably, such a power supply source 1 transmits a brake power signal to the G-force meter only when the brake switch 3 is activated during vehicle braking procedures. In this manner, the G-force meter 5 determines a G-force value inside the vehicle only upon receiving the brake power signal.

Referring initially to FIG. 1, a schematic diagram of the first embodiment is illustrated as including a 12-volt battery power supply source 1 electrically coupled to a 12-volt power line 2 when the car ignition switch is on. As long as the car ignition switch is on, the AFBL has a constant supply of 12-volt. Brake switch 3 is communicatively coupled to a G-force meter 5 via brake power line 2. In this manner, as a driver pushes down a brake pedal (not shown), a 12-volt brake power signal is transmitted to G-force meter 5. As brake pressure is applied to the brake pedal, digitalized G-Force meter 5 is activated and reads out the G-force value. The combination of such claimed elements solves the problem of generating false or premature G-force values when the vehicle swerves or switches gears abruptly, without actually braking, and thereby provides an unpredictable and unexpected result which is not rendered obvious by one skilled in the art because it calculates the G-force value only when pressure is applied to the brake pedal.

A processor 6 may be communicatively coupled to the G-force meter 5 and may be responsive to the G-force value such that the processor 6 generates and transmits corresponding brake light signals to selected ones of the brake lights 12-14, as perhaps best shown in FIG. 2. In this manner, the brake lights 12-14 are caused to flash at different frequencies upon receiving the corresponding brake light signals.

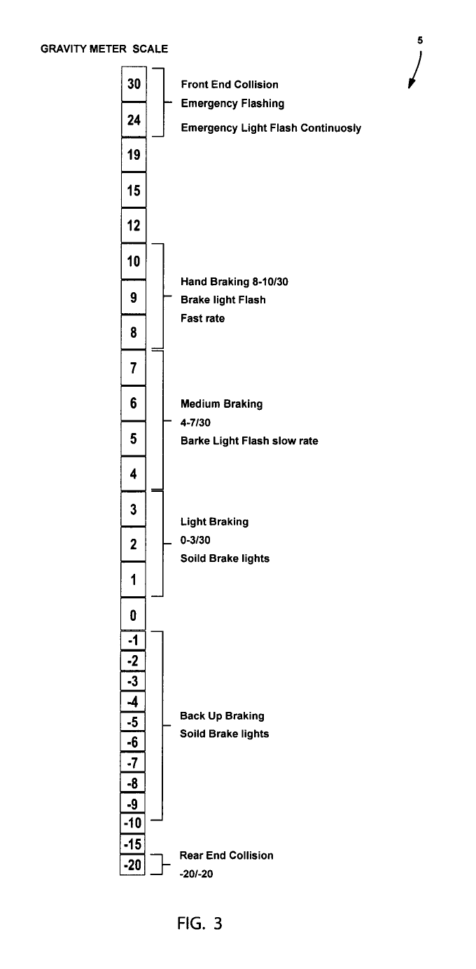

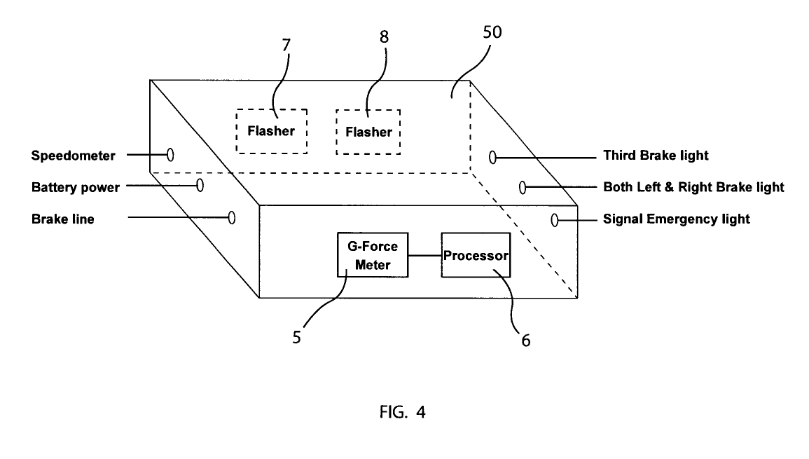

Referring to FIGS. 3 and 4, G-force meter 5 may be gravity actuated and may be situated within the housing 50 for measuring the G-force inside the vehicle. Suitable G-force meters may include a calibrated accelerometer to measure the G-force along one or more axes, only when the brake pedal is actuated. If a stationary, single-axis accelerometer is oriented so that its measuring axis is horizontal, its output will be 0 g, and it will continue to be 0 g if mounted in an automobile traveling at a constant velocity on a level road. But if the vehicle driver brakes sharply, the signal from the brake pedal is transmitted to the G-force meter 5, which will determine the G-force value at the instance of braking, corresponding to a deceleration.

In one embodiment 10, the present invention may further include a plurality of flasher devices 7, 8 for altering the different flashing frequencies of brake lights 12-14. A plurality of communication links a-d are communicatively coupled to the flasher devices 7, 8 and the brake lights 12-14, respectively. Processor 6 receives the G-force values such as a high G-force, moderate G-force, light G-force and extremely high or extremely high negative G-force, as perhaps best illustrated in FIG. 3. According to these different G-force values, the processor 6 generates and transmits corresponding signals using communication links a, b, c, and d to the flasher devices 7, 8 and/or vehicle brake lights 12-14.

In one embodiment 10, the flasher devices may include a fast flasher device 7 communicatively coupled to the processor 6 and thereby receiving a high one of the G-force values via a first one of the communication links a. In addition, a slow flasher device 8 may be communicatively coupled to the processor 6 and thereby receives a medium one of the G-force values via a second one of the communication links b. A weak G-force signal is communicated to a no signal detection unit 9 via communication link c, which represents solid regular brake lights.

As perhaps best shown in FIGS. 1 and 3, extremely high positive or extremely high negative G-force signals may be transmitted to the emergency lights 14 via the slower flasher device 8 via relay switches 10, 11. The combination of such claimed elements solves the problem of not knowing whether the G-force value is attributed to sudden acceleration or deceleration and thereby provides an unpredictable and unexpected result which is not rendered obvious by one skilled in the art.

Referring to FIG. 1, the no signal detection unit 9 will trigger to receive the original brake signal via relay switch 10 during system failure. Relay switch 11 may receive all the brake light signals and thereafter relays it to a third brake light 12 as well as left and right brake lights 13, except for emergency brake lights 14. The no signal detection unit 9 may be communicatively coupled to the processor 6 as well as the fast and slow flasher devices 7, 8 respectively via a third one of the communication links c. In this manner, a weak one of the G-force values may be communicated to the no signal detection unit 9 via the third communication link c.

In one embodiment 10, a plurality of relay switches 10-11 may be communicatively coupled to the G-force meter 5, wherein an extremely high positive G-force value and an extremely high negative G-force value is transmitted to an emergency one of the brake lights 14 via the slower flasher device 8 and the relay switches 10-11, respectively. In this manner, the no signal detection unit 9 will trigger to receive the brake power signal via a first one of the relay switches 10 during system failure such that the first and second relay switches 10, 11 receive the brake light signals and thereafter relay the brake light signals to left and right ones 13 of the brake lights as well as a third one 12 of the brake lights, respectively.

In one embodiment 10, as perhaps best shown in FIG. 1, a digital speedometer 15 may be communicatively coupled to processor 6, for vehicles that employ digitized speedometers 15.

Now referring to FIG. 2, a schematic diagram of the second embodiment is illustrated as including a 12-Volt power line 1 when the ignition switch is on, which is connected to brake switch 3. As the brake pedal is applied, a brake signal power goes into the G-force meter 5. According to the different G-force value this meter feeds its readings into the central processor unit 6. According to the different G-force reading, the processor 6 transmits different signals to different light units 12-14.

Such a central processor unit 6 may include a flashing program associated with each different light unit 12-14 such that flasher devices 7, 8 are not necessary. The combination of such claimed elements solves the problem of not knowing the rate of vehicle deceleration and thereby provides an unpredictable and unexpected result which is not rendered obvious by one skilled in the art because it flashes the vehicle brake lights are different frequencies and time periods commensurate with the detected G-force value.

Brake light units 12-14 may utilize LED lights for self-flashing or regular light lamps if such light units 12-14 communicate with the flashing program device of the central processor unit 6. A power line 30 may bypass the G-force meter 5 and thereby transmit the 12-volt power directly to the process 6 when the ignition switch is on. Such a power line 30 is useful when the collision occurs for constant emergency flashing lights 14. The combination of such claimed elements solves the problem of not being able to continuously notify trailing vehicles of the stopped leading vehicle after an accident has happened and the brake pedal has been released. Such an advantage provides an unpredictable and unexpected result which is not rendered obvious by one skilled in the art.

FIG. 3 illustrates an exemplary embodiment of the G-force meter 5 wherein numerical values are displayed on the G-force meter 5. Such numerical values range between positive 30 and negative 20, for example. Selected groups of numerical values are associated with a corresponding G-force value. The positive G-force values may be associated with forward vehicle movement and the negative numbers may be associated with rearward vehicle movement, respectively. For example, a high positive G-force value may range between positive 24 and 20, which corresponds to a front end collision such that the emergency light flashing continuously.

In another example, another G-force value may be negative 20, which may be a high negative value, which corresponds to rear end collision. G-force values around zero are associated with light braking and back-up braking. The combination of such claimed elements solves the problem of not knowing whether the vehicle has an abrupt change in acceleration or deceleration and thereby provides an unpredictable and unexpected result which is not rendered obvious by one skilled in the art.

The present invention further includes a method of utilizing an automatic vehicle brake light flashing system 10 for identifying an extremity of a vehicle braking force. Such a method preferably includes the chronological steps of: providing and connecting a plurality of brake lights 12-14 to an existing vehicle; providing a power supply source 1; providing a G-force meter 5; providing communicatively coupling a brake switch 3 to the G-force meter 5 and the power supply source 1, respectively.

Such a method may further include the chronological steps of: the power supply source 1 transmitting a brake power signal to the G-force meter 5 only when the brake switch 3 is activated during vehicle braking procedures; the G-force meter 5 determining a G-force value inside the vehicle only upon receiving the brake power signal; providing and communicatively coupling processor 6 to the G-force meter 5 and being responsive to the G-force value; processor 6 generating and transmitting corresponding brake light signals to selected ones of the brake lights 12-14; and upon receiving the corresponding brake light signals, the brake lights 12-14 to flash at different frequencies.

Better and earlier recognition of brake warning lights can prevent rear-end collisions and accidents. When faced with many similar objects, something different in appearance draws out attention quicker even when it is in the peripheral view. When faced with similarly fixed objects, we notice the ones that move slightly right away. When faced with a sea of rear red lights, we notice a bright red brake light easily.

In particular, instead of just regular bright red brake lights, if the brake lights flash it will be noticed more quickly by the driver behind and they can act sooner. Some drivers turn on emergency flashing lights or pump their brakes to make the vehicle brake lights flash in order to warn the driver of a trailing vehicle to be on guard for a potential driving hazard. It is important to note that such turning on of emergency lights or pumping action lengthens the stopping distance and, therefore, cannot always be used to warn the drivers behind them. Also anti-lock brake systems discourage pumping of the brakes.

It is well accepted that all drivers have been indoctrinated to respond quickly to flashing lights, especially red flashing lights. It is a wake-up call to everyone. The present invention solves such problems by utilizing brake light as a flashing and solid brake light device to indicate that a vehicle's brakes are being applied and the vehicle is stopping/slowing down.

If we know the front driver's intention earlier and better, we can avoid many accidents. What this means is that a brake system equipped with better visibility and quicker recognition can prevent collision accidents, thus saving lives and money.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. An automatic vehicle brake light flashing system for identifying an extremity of a vehicle braking force, said automatic vehicle brake light flashing system comprising:
a plurality of brake lights adapted to be connected to an existing vehicle;
a power supply source;
a G-force meter; and
a brake switch communicatively coupled to said G-force meter and said power supply source respectively;
wherein said power supply source transmits a brake power signal to said G-force meter when said brake switch is activated during vehicle braking procedures;
wherein said G-force meter determines a G-force value inside the vehicle only upon receiving said brake power signal;
a processor communicatively coupled to said G-force meter and being responsive to said G-force value such that said processor generates and transmits corresponding brake light signals to selected ones of said brake lights;
wherein said brake lights are caused to flash at different frequencies upon receiving said corresponding brake light signals.

2. The automatic vehicle brake light flashing system of claim 1, further comprising:
a plurality of flasher devices for altering said different frequencies; and
a plurality of communication links communicatively coupled to said flasher devices and said brake lights respectively.

3. The automatic vehicle brake light flashing system of claim 2, wherein said flasher devices comprise:
a fast flasher device communicatively coupled to said processor and thereby receiving a high one of said G-force values via a first one of said communication links; and
a slow flasher device communicatively coupled to said processor and thereby receiving a medium one of said G-force values via a second one of said communication links.

4. The automatic vehicle brake light flashing system of claim 3, further comprising:
a no signal detection unit communicatively coupled to said processor and said fast and slow flasher units respectively via a third one of said communication links;
wherein a weak one of said G-force values is communicated to said no signal detection unit via said third communication link.

5. The automatic vehicle brake light flashing system of claim 4, further comprising: a plurality of relay switches communicatively coupled to said G-force meter, wherein an extremely high positive G-force value and an extremely high negative G-force value is transmitted to an emergency one of said brake lights via said slower flasher device and said relay switches respectively.

6. The automatic vehicle brake light flashing system of claim 5, wherein said no signal detection unit will trigger to receive said brake power signal via a first one of said relay switches during system failure such that said first and second relay switches receive said brake light signals and thereafter relays said brake light signals to left and right ones of said brake lights as well as a third one of said brake lights respectively.

7. An automatic vehicle brake light flashing system for identifying an extremity of a vehicle braking force, said automatic vehicle brake light flashing system comprising:
a plurality of brake lights adapted to be connected to an existing vehicle;
a power supply source;
a G-force meter; and
a brake switch communicatively coupled to said G-force meter and said power supply source respectively;
wherein said power supply source transmits a brake power signal to said G-force meter only when said brake switch is activated during vehicle braking procedures;
wherein said G-force meter determines a G-force value inside the vehicle only upon receiving said brake power signal;
a processor communicatively coupled to said G-force meter and being responsive to said G-force value such that said processor generates and transmits corresponding brake light signals to selected ones of said brake lights;
wherein said brake lights are caused to flash at different frequencies upon receiving said corresponding brake light signals.

8. The automatic vehicle brake light flashing system of claim 7, further comprising:
a plurality of flasher devices for altering said different frequencies; and
a plurality of communication links communicatively coupled to said flasher devices and said brake lights respectively.

9. The automatic vehicle brake light flashing system of claim 8, wherein said flasher devices comprise:
a fast flasher device communicatively coupled to said processor and thereby receiving a high one of said G-force values via a first one of said communication links; and
a slow flasher device communicatively coupled to said processor and thereby receiving a medium one of said G-force values via a second one of said communication links.

10. The automatic vehicle brake light flashing system of claim 9, further comprising:
a no signal detection unit communicatively coupled to said processor and said fast and slow flasher units respectively via a third one of said communication links;
wherein a weak one of said G-force values is communicated to said no signal detection unit via said third communication link.

11. The automatic vehicle brake light flashing system of claim 10, further comprising: a plurality of relay switches communicatively coupled to said G-force meter, wherein an extremely high positive G-force value and an extremely high negative G-force value is transmitted to an emergency one of said brake lights via said slower flasher device and said relay switches respectively.

12. The automatic vehicle brake light flashing system of claim 11, wherein said no signal detection unit will trigger to receive said brake power signal via a first one of said relay switches during system failure such that said first and second relay switches receive said brake light signals and thereafter relays said brake light signals to left and right ones of said brake lights as well as a third one of said brake lights respectively.

13. A method of utilizing an automatic vehicle brake light flashing system for identifying an extremity of a vehicle braking force, said method comprising the chronological steps of:
providing and connecting a plurality of brake lights to an existing vehicle;
providing a power supply source;
providing a G-force meter;
providing communicatively coupling a brake switch to said G-force meter and said power supply source respectively;
said power supply source transmitting a brake power signal to said G-force meter only when said brake switch is activated during vehicle braking procedures;
said G-force meter determining a G-force value inside the vehicle only upon receiving said brake power signal;
providing and communicatively coupling a processor to said G-force meter and being responsive to said G-force value;
said processor generating and transmitting corresponding brake light signals to selected ones of said brake lights; and
upon receiving said corresponding brake light signals, said brake lights to flash at different frequencies.
